(19) United States
(12) Patent Application Publication
(10) Pub. No.: US 2005/0248940 A1
(43) Pub. Date: Nov. 10, 2005

(54) Lamp body structure for lamp string

(76) Inventor: Hon Kwok Cheng, Kowloon (HK)

Correspondence Address: RABIN & Berdo, PC, 1101 14TH STREET, NW, SUITE 500, WASHINGTON, DC, 20005, US

(21) Appl. No.: 11/123,079

(22) Filed: May 6, 2005

(30) Foreign Application Priority Data
May 8, 2004 (CN) 200420050499.9

(51) Int. Cl. F21S 2/00

(52) U.S. Cl. 362/227

(57) ABSTRACT

The invention relates to a lamp body structure for a string of lamps comprising an upper ornamental portion and a lower housing portion, characterized in that the upper ornamental portion is a transparent enclosure, the lower housing portion is a transparent hollow cylinder, the upper ornamental portion is connected to the lower housing portion by means of a plug member; lamp wires or a series of small bulbs are mounted inside both the upper ornamental portion and the lower housing portion; the bottom portion of the lower housing portion is provided with a conical fixed insertion member. The lamp body structure for a string of lamps according to the invention has a simple structure and is conveniently installed and assembled with high reliability and easy maintenance in comparison with the existing ones.

### FIELD OF THE INVENTION

The present invention relates to a lamp body structure for a string of lamps in which small bulbs are mounted, and to an improvement on structures of the existing arrangements and an increase in performance thereof.

### BACKGROUND OF THE INVENTION

The existing lamp body structures for a string of lamps are comprised of lamp wires or a string of small bulbs, on the exterior of which accessories such as ornaments or protective housings are not provided. These lamp fixtures can serve as a decoration, however, they are entirely exposed to the outside environment to make it possible all components and circuits thereof are vulnerable; on the other hand, they are small in size, leading to difficulties in connecting and securing, and they are also easily damaged when improperly connected and secured. Said lamp fixtures are relatively unreliable after being connected so that they are often out of order and laborious inspection and maintenance are required. Moreover, the installation of said lamp fixtures onto the ground or other buildings is not sufficiently firm. Therefore, there remain some drawbacks with the existing lamp body structures.

### SUMMARY OF THE INVENTION

To overcome the drawbacks in existence, it is an object of the present invention to provide a novel lamp body structure for a string of lamps, which has a simple structure and is conveniently installed and assembled with high reliability and easy maintenance.

In order to accomplish the aforesaid object, there is provided a lamp body structure for a string of lamps comprising an upper ornamental portion and a lower housing portion, characterized in that the upper ornamental portion is a transparent enclosure, the lower housing portion is a transparent hollow cylinder, the upper ornamental portion is connected to the lower housing portion by means of a plug member; lamp wires or a series of small bulbs are mounted inside both the upper ornamental portion and the lower housing portion; the bottom portion of the lower housing portion is provided with a conical fixed insertion member.

Besides the transparent ornament on the top, the lamp wires or a series of small bulbs are mounted and fixed inside the elongated and cylindrical transparent housing, thereby providing a stable and reliable installation and a convenient assembly, as well as producing an aesthetic impression.

The invention will now be described in more detail with reference to the accompanying FIGURE drawing.

### BRIEF DESCRIPTION OF THE DRAWINGS

FIG. 1 is a schematic diagram showing the internal construction and the assembly of a preferred embodiment according to the invention.

### DETAILED DESCRIPTION OF THE INVENTION

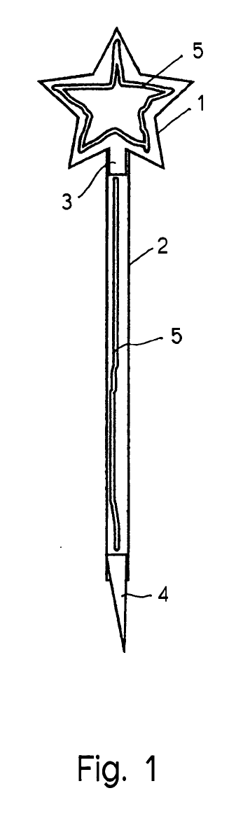

Referring to FIG. 1, a lamp body structure for a string of lamps constructed according to one of the preferred embodiment comprises an upper ornamental portion 1 and a lower housing portion 2, characterized in that the upper ornamental portion 1 is a transparent enclosure in the form of pentagram, the lower housing portion 2 is an elongated transparent cylinder, the upper ornamental portion 1 is connected to the lower housing portion 2 by means of a plug member 3; lamp wires 5 or a series of small bulbs are mounted inside both the upper ornamental portion 1 and the lower housing portion 2; the bottom portion of the lower housing portion 2 is also provided with a conical fixed insertion member 4 for embedding into the ground and the like so that the entire lamp body is secured thereto.

Besides the transparent ornament on the top, lamp wires or a series of small bulbs are mounted and fixed inside the elongated and cylindrical transparent housing, thereby providing a stable and reliable installation and a convenient assembly, as well as producing an aesthetic impression. As a result, the entire lamp body is not vulnerable to breakdown.

The lamp body structure for a string of lamps according to the invention has a simple structure and is conveniently installed and assembled with high reliability and easy maintenance in comparison with the existing ones.

Numerous variations and modifications are easily obtainable by means of the skilled person's common knowledge without departing from the scope of the invention, however, such variations and modifications should fall into the scope of this invention.

1. A lamp body structure for a string of lamps comprising an upper ornamental portion (1) and a lower housing portion (2), characterized in that the upper ornamental portion (1) is a transparent enclosure, the lower housing portion (2) is a transparent hollow cylinder, the upper ornamental portion (1) is connected to the lower housing portion (2) by means of a plug member (3); lamp wires (5) or a series of small bulbs are mounted inside both the upper ornamental portion (1) and the lower housing portion (2); the bottom portion of the lower housing portion (2) is provided with a conical fixed insertion member (4).
